(19) United States
(12) Patent Application Publication
(10) Pub. No.: US 2013/0294563 A1
(43) Pub. Date: Nov. 7, 2013

(54) FAST REACTOR AND FAST REACTOR REFLECTOR ASSEMBLY

(71) Applicant: Kabushiki Kaisha Toshiba, Tokyo (JP)

(72) Inventors: Akito NAGATA, Tokyo (JP); Yasushi Tsuboi, Kanagawa-ken (JP); Takanari Inatomi, Kanagawa-ken (JP); Kouhei Tarutani, Kanagawa-ken (JP); Tugio Yokoyama, Kanagawa-ken (JP); Masatoshi Kawashima, Kanagawa-ken (JP)

(73) Assignee: Kabushiki Kaisha Toshiba, Tokyo (JP)

(21) Appl. No.: 13/860,645

(22) Filed: Apr. 11, 2013

(30) Foreign Application Priority Data
Apr. 12, 2012 (JP) 2012-090813

(51) Int. Cl. G21C 7/28

(52) U.S. Cl. CPC G21C 7/28
USPC 376/220

(57) ABSTRACT

A fast reactor performing reflector control to control reactivity of the core by moving a neutron reflector in the vertical direction, including: a core fuel assembly; a neutron absorption assembly in the middle of the core fuel assembly; a reflector assembly at the circumference of the core fuel assembly; plural inner neutron shields at the circumference of the reflector assembly; a cylindrical core barrel surrounding entirety of the plural neutron shields; and a drive mechanism controlling the reflector. The reflector assembly includes: a reflector element that reflects neutrons from the core fuel assembly towards the core; a cavity section, arranged thereabove, that permits leakage of neutrons to outside the core; a linkage mechanism that links the reflector element and the cavity section; a guide tube that defines a space for removal/insertion of these; and a connecting section that connects the drive mechanism and the cavity section.

### CROSS REFERENCE TO RELATED APPLICATION

This application claims benefit of priority from Japanese Application No. JP2012-90813 filed Apr. 12, 2012, the entire contents of which are incorporated by reference herein.

### FIELD

Embodiments described herein relate generally to a reflector-controlled type fast reactor, and to a reflector assembly used therein.

### BACKGROUND

In a fast reactor in which liquid metal is employed as the coolant, the reactor vessel has the important function of containing the coolant in the event of an accident; consequently, the reactivity of the core is controlled by insertion or removal of control rods into the core from above.

The drive device for the control rods is therefore positioned above the core: there is therefore the problem that this necessitates the provision of a core top mechanism or the like above the core, which makes the construction of the reactor more complicated and tends to increase its weight and cost.

Accordingly, in for example Japanese Laid-open Patent Application Number Tokkai 2005-233751 (hereinafter referred to as Patent Reference 1), reactor technology of the reflector-controlled type has been disclosed, in which the reactivity of the core is controlled by adjustment of neutron leakage from the core by moving a neutron reflector provided outside the core in the vertical direction.

FIG. 1 is a horizontal cross-sectional view showing the reactor peripheral layout in a reactor vessel according to an example of a prior art fast reactor. Also, FIG. 2 is a vertical cross-sectional view showing the reactor peripheral layout in a reactor vessel according to an example of a prior art fast reactor.

In the fast reactor of this example, a single neutron absorption assembly 12 is arranged in the middle and 18 core fuel assemblies 11 are arranged at the periphery, being provided in two layers in the radial direction. A circular core barrel 16 is arranged outside these core fuel assemblies 11 so as to surround these in the radial direction, and a reflector movement zone 100 constituted by an annular space of the neutron reflector is provided between the outside of the core barrel 16 and a shroud 17, and a plurality of sector-shaped reflector devices or fan-shaped reflector devices, not shown, are arranged therein. The reflector devices are moved in the perpendicular direction through the interior of the reflector movement zone 100 and are provided with reflector sections 110 and a cavity section 120 at the top thereof. A neutron shield 15 is provided outside this reflector movement zone 100.

The weight of the core fuel assemblies 11 constituting the core is supported from below by a core support plate, not shown. Furthermore, if the fuel assemblies 11 are subjected to load in the horizontal direction for example by an earthquake or the like, the load acting on the top of these fuel assemblies 11 is transmitted to the core barrel 16 and is thence transmitted to the reactor vessel 1 through a load transmission path such as a linkage construction at the top of the reflector movement zone 100 outside the core barrel 16.

With such a core construction, with increase in the life of the power plant, the amount of neutron irradiation is increased, so a ferrite material that can withstand high levels of irradiation is employed as the material of the core barrel 16. However, if further prolongation of the life of the power plant is envisioned, it is thought that replacement of the reactor barrel may be necessitated by irradiation-induced degradation of the barrel material.

For example, albeit a fast reactor has the advantage that fuel replacement during the reactor life is unnecessary or need only be performed a very small number of times, reducing the risk of diffusion of the nuclear material or raising the nonproliferation of the nuclear material, such irradiation-induced degradation of the barrel material has the effect of reducing this advantage, because it makes it necessary to open up the reactor vessel in order to replace the core barrel. Also, it is necessary to adopt a construction of the reactor vessel interior and its periphery such as will enable reactor barrel replacement during the period of operation of the power plant: this results in increased costs.

According to an aspect of the present technology, an object of the present invention is therefore to provide a reflector construction whereby replacement of the core barrel due to irradiation-induced degradation is unnecessary, even in cases where the life of the power plant is further moved.

In order to achieve the above object, the present invention is constructed as follows. Specifically,
a fast reactor in which reflector control is performed to control the core reactivity, by adjusting neutron leakage from the core by moving in the vertical direction a neutron reflector that is arranged radially outside the core, which is bathed in liquid metal coolant, comprising:
a plurality of core fuel assemblies that move in mutually parallel fashion in the vertical direction;
a neutron absorption assembly that moves in the vertical direction, provided in the middle in the horizontal direction of said plurality of core fuel assemblies;
a plurality of reflector assemblies moving in the vertical direction, arranged in the horizontal peripheral region of said core fuel assemblies;
a plurality of neutron shields arranged in the horizontal peripheral region of said core fuel assemblies;
a cylindrical core barrel provided surrounding the entirety of said plurality of neutron shields in the horizontal direction; and
a drive mechanism for said reflector control,
wherein said reflector assemblies comprise:
   a reflector element that reflects neutrons flowing out from said core fuel assembly towards the core;
   a hollow cavity section arranged perpendicularly above said reflector element for permitting leakage of the neutrons flowing out from said core fuel assembly towards outside the core;
   a linkage mechanism that links said reflector element and said cavity section;
   a guide tube defining a space for insertion/removal of said reflector element, said cavity section and said linkage mechanism; and
   a connecting section that connects said drive mechanism and said cavity section,
wherein said reflector element and said cavity section are moved vertically through the interior of said guide tube by said drive mechanism.

Also, further according to the present invention, the following construction is provided. Specifically,
a reflector-controlled type fast reactor reflector assembly, in which the core reactivity is controlled by adjusting neutron leakage from the core by moving in the vertical direction a neutron reflector that is arranged radially outside the core, which is bathed in liquid metal coolant, comprising:
a reflector element that reflects neutrons flowing out from said core fuel assembly towards the core; a hollow cavity section arranged perpendicularly above said reflector element for permitting leakage of the neutrons flowing out from said core fuel assembly towards outside the core;
a linkage mechanism that links said reflector element and said cavity section;
a guide tube defining a space for insertion/removal of said reflector element, said cavity section and said linkage mechanism; and
a connecting section that connects said drive mechanism and said cavity section,
wherein said reflector element and said cavity section are moved vertically through the interior of said guide tube by said drive mechanism.

According to the present invention, replacement of the core barrel due to high irradiation-induced degradation is unnecessary, even in cases where the life of the power plant is further moved.

### BRIEF DESCRIPTION OF THE DRAWINGS

FIG. 1 is a horizontal cross-sectional view showing the construction of the core periphery in a reactor vessel according to an example of a conventional fast reactor;

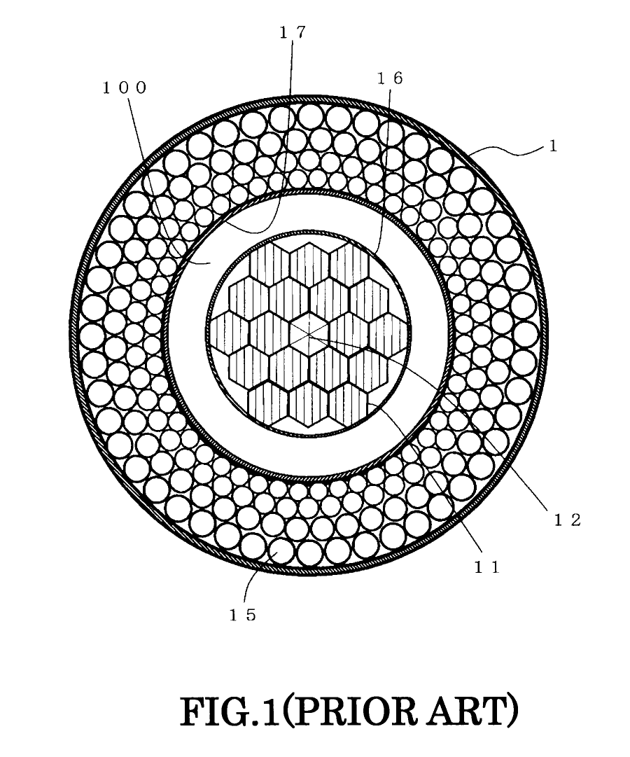

FIG. 2 is a vertical cross-sectional view showing the construction of the core periphery in a reactor vessel according to an example of a conventional fast reactor;

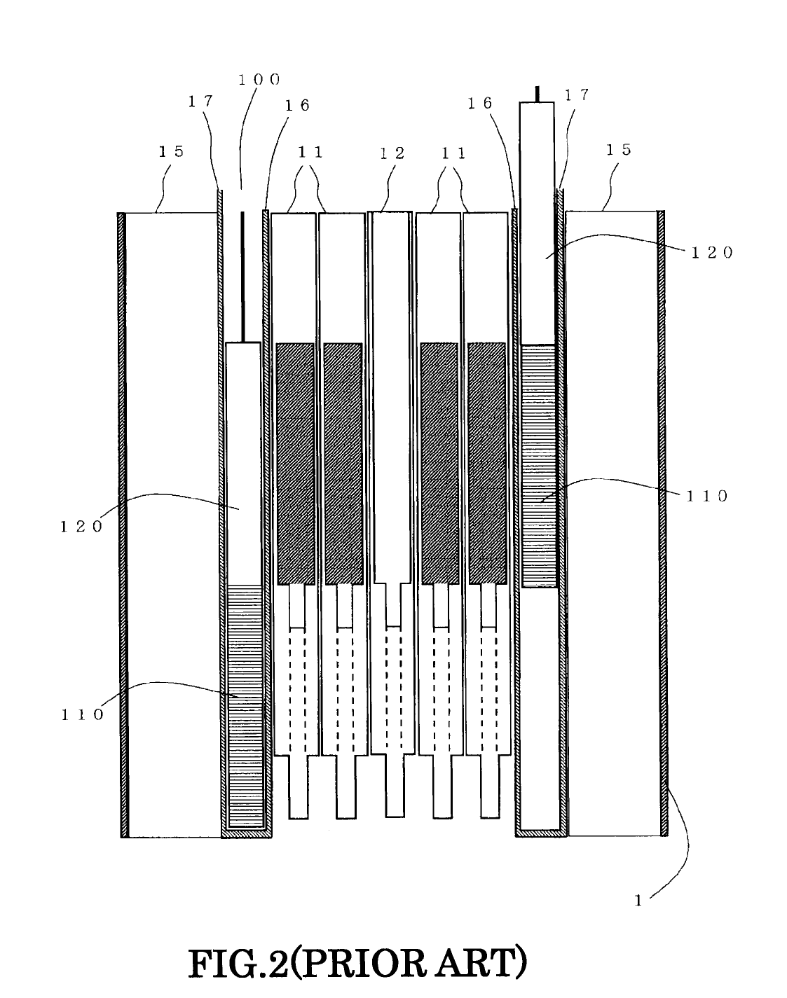

FIG. 3 is a horizontal cross-sectional view showing the construction of the core periphery in a reactor vessel according to a first embodiment of a fast reactor according to the present invention;

FIG. 4 is a vertical cross-sectional view showing the construction of the core periphery in a reactor vessel according to a first embodiment of a fast reactor according to the present invention;

FIG. 5 is a bird's eye view showing a reflector assembly constituting a first embodiment of a fast reactor according to the present invention;

FIG. 6 is a bird's eye view showing a reflector assembly constituting a second embodiment of a fast reactor according to the present invention;

FIG. 7 is a vertical cross-sectional view showing a reflector assembly constituting a third embodiment of a fast reactor according to the present invention;

FIG. 8 is a bird's eye view showing a reflector assembly constituting a fourth embodiment of a fast reactor according to the present invention.

### DETAILED DESCRIPTION

Embodiments of a fast reactor according to the present invention and a reflector assembly for a fast reactor are described below with reference to the drawings. Identical or similar portions are given the same reference symbols, to avoid repeated description.

### First Embodiment

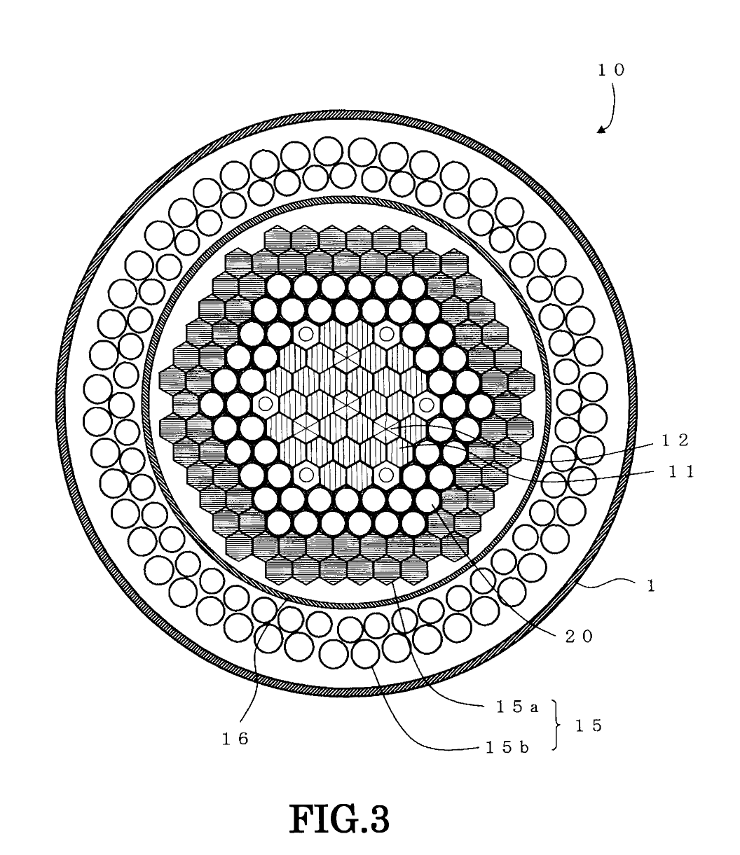

FIG. 3 is a horizontal cross-sectional view showing the construction of the core periphery in a reactor vessel according to a first embodiment of a fast reactor according to the present invention.

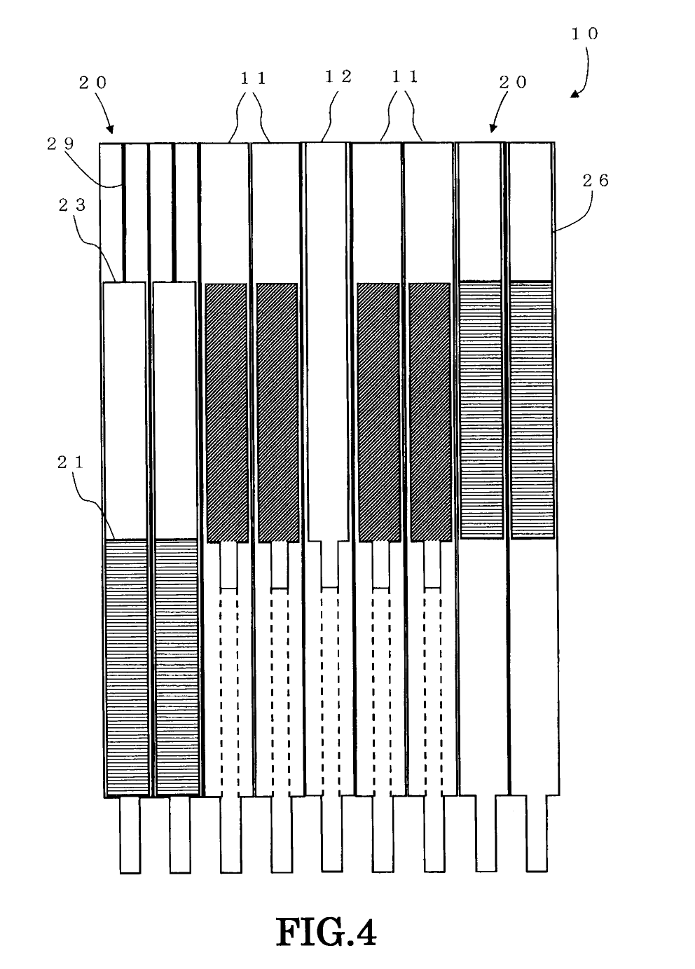

FIG. 4 is a vertical cross-sectional view showing the construction of the core periphery in a reactor vessel according to a first embodiment of a fast reactor according to the present invention;

The present invention relates to a fast reactor that is cooled by liquid metal and in which reflector control is performed to control the reactivity of the core, by adjusting leakage of neutrons from the core, by moving a neutron reflector arranged radially outside the core in the vertical direction.

The core constituent elements that are arranged around the core of a reactor 10 in a reactor vessel 1, as shown, comprise: core fuel assemblies 11, neutron absorption assemblies 12, reflector assemblies 20, and neutron shields 15 comprising inner neutron shields 15a and outer neutron shields 15b; these are arranged in mutually parallel fashion moving vertically in the perpendicular direction.

27 core fuel assemblies 11 are provided. In the middle of the core fuel assemblies 11, there is provided a single neutron absorption assembly 12 and three neutron absorption assemblies 12 are provided outside the core fuel assemblies 11. These neutron absorption assemblies 12 are inserted when the reactor 10 is to be shut down.

The region radially outside the core fuel assemblies 11 and neutron absorption assemblies 12 is surrounded by reflector assemblies 20. There are provided 60 reflector assemblies 20, arranged in two layers in the radial direction.

The outside in the radial direction of the reflector assemblies 20 is surrounded by inner neutron shields 15a. There are 120 inner neutron shields 15a, arranged in two layers in the radial direction.

A cylindrical core barrel 16 is provided surrounding in the horizontal direction the entirety of the inner neutron shields 15a, on the radial outside of the inner neutron shields 15a.

The core constituent elements inside the core barrel 16, specifically, the core fuel assemblies 11, neutron absorption assemblies 12, reflector assemblies 20 and inner neutron shields 15a are all of the same external hexagonal shape, with their adjacent faces opposite each other and these opposite faces being mutually parallel.

A plurality of outer neutron shields 15b are provided outside the core barrel 16, forming two layers in the radial direction.

The outside of the outer neutron shields 15b is surrounded by the reactor vessel 1.

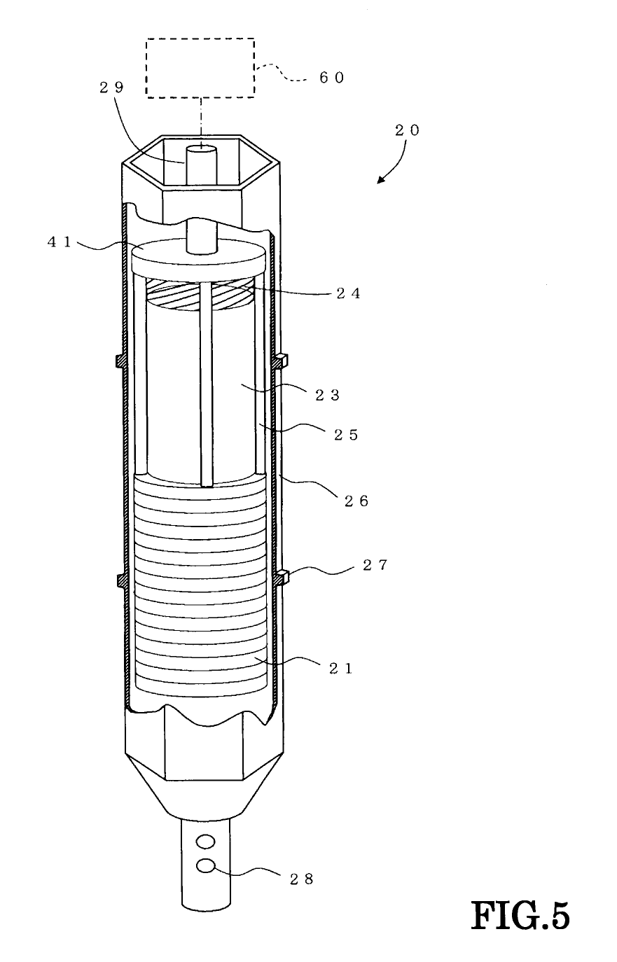

FIG. 5 is a bird's eye view showing a reflector assembly constituting an embodiment of a fast reactor according to the present invention.

A reflector assembly is provided with a guide tube 26 made of stainless steel at its radially outermost section. The external shape of the guide tube 26 in horizontal section is a regular hexagon. However, its bottom portion is of cylindrical shape of smaller diameter, for the insertion of a core support plate, not shown, and is provided with a plurality of orifices 28 for inflow of coolant such as for example liquid metal such as liquid metallic sodium.

The material of the guide tube 26 is not restricted to stainless steel but should be a material of small neutron absorption cross-section, such as aluminum or zirconium.

Also, convex-shaped pads 27 are provided at the entire circumference of the outside of the guide tube 26 in the radially outwards direction at the same height in the perpendicular direction. The pads 27 are provided at a plurality of heights in the perpendicular direction.

A reflector element 21 and a cavity section 23 are accommodated in the interior of the guide tube 26. The reflector element 21 is suspended through a plurality of connecting rods 25 by means of a suspension disc 41. A cavity section 23 and a spring 24 at the top thereof are provided between the reflector element 21 and the suspension disc 41, so that the cavity section 23 is pressed towards the reflector element 21 by the spring 24.

The plurality of connecting rods 25 are subjected to reaction when the spring 24 presses the reflector element 21, and restrict sideways movement thereof in the radial direction of the cavity section 23.

The suspension disc 41 is connected with a drive mechanism 60 through a connecting section 29 and is moved by the drive mechanism 60 in the perpendicular direction through the space within the guide tube 29 integrally with the suspension disc 41, connecting rods 25, reflector element 21, spring 24 and cavity section 23.

The elements that move through the interior of the guide tube 26 are of circular external shape in horizontal cross-section, and thus cannot interfere with the inside of the guide tube 26 with regard to the direction of rotation and so do not need to be fixed in the direction of rotation in order to avoid buffering and hence can be simplified in construction.

The reflector element 21 reflects neutrons from the core fuel assemblies 11 towards the core and is of a laminated construction in which discs of material, such as for example stainless steel, having a reflective effect for neutrons are laminated in unitary fashion. Also, the radial periphery of the laminated structure of the reflector elements 21 is covered with a covering, not shown.

The cavity section 23 is a vessel that defines a space to allow leakage of neutrons from the core fuel assemblies 11 directly, without reflection, to outside the core, and has sealed in its interior an inert gas such as for example argon.

With this embodiment constructed as described above, the core barrel 16 is provided outside the region where the inner neutron shields 15a are arranged, whereas, in the prior art example, the core barrel 16 is arranged immediately outside the region of the core fuel assemblies 11: thus there is a considerable difference in regard to the positional relationship thereof with respect to the core fuel assemblies 11.

Specifically, in this embodiment, the reflector assemblies 20 and inner neutron shields 15a are interposed between the core fuel assemblies 11 and the core barrel 16, so the neutron irradiation flux received by the core barrel 16 is greatly reduced.

Consequently, in this embodiment, replacement of the core barrel caused by the high level of irradiation can be rendered unnecessary, even when the power plant life is further moved.

### Second Embodiment

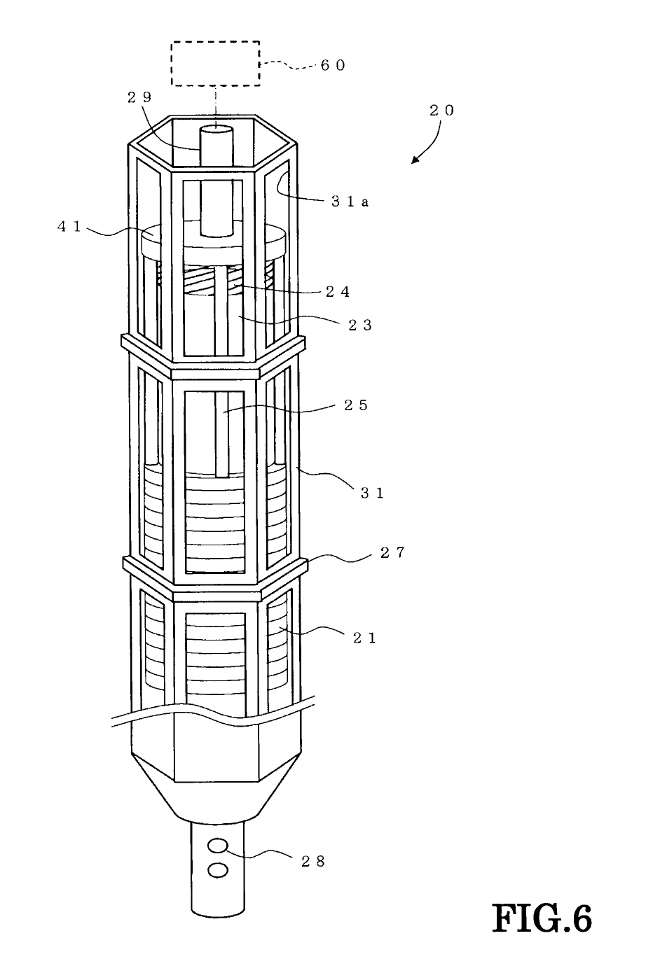

FIG. 6 is a bird's eye view showing a reflector assembly constituting a second embodiment of a fast reactor according to the present invention.

This embodiment is a modification of the first embodiment. Whereas, in the case of the first embodiment, the cross-sectional shape of the guide tube 26 is externally a regular hexagonal shape, the guide tube of this embodiment is a guide tube 31 furnished with apertures having apertures 31a such as to permit passage of neutrons at each side face thereof.

The apertures 31a consist in apertures 31a constituting the major portion of the side face, excluding a sufficient portion for the pads 27 and edges of the regular hexagonal prism that is necessary in order to guarantee structural strength of the guide tube 31 furnished with apertures.

With the reflector assemblies 20 according to the present embodiment, owing to the provision of the apertures 31a at the side faces of the guide tube 31 furnished with apertures, neutrons from the core fuel assemblies 11 arrive directly at the reflector elements 21 by passing through the apertures 31a: reflection efficiency is thereby improved. Control of the reactivity by the reflector assemblies 20 is thereby made more reliable.

With the construction of the present embodiment as described above, even in cases where the power plant life is further moved, replacement of the core barrel caused by high irradiation levels can be made unnecessary and more reliable reflector control can be achieved.

### Third Embodiment

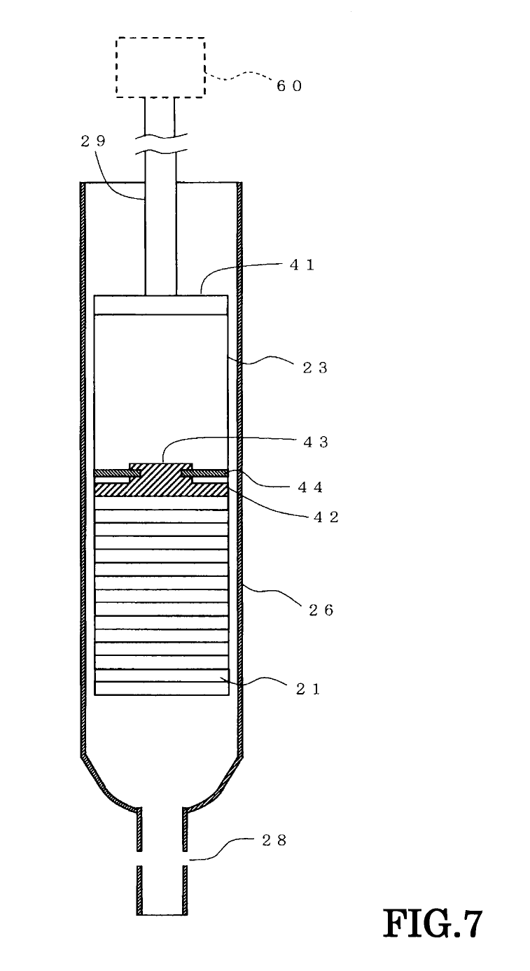

FIG. 7 is a vertical cross-sectional view showing a reflector assembly constituting a third embodiment of a fast reactor according to the present invention.

In this embodiment, the linkage of the reflector elements 21 and the cavity sections 23 is different from that of the first embodiment etc. Specifically, in this embodiment, the reflector element 21 and the cavity section 23 are fitted together in telescopic fashion, and this fitting together is secured by means of bolts 44.

As shown in FIG. 7, the reflector element 21 has a convex section 42 at the top thereof. Also, the cavity section 23 has a concave section 43 at the bottom thereof. The convex section 42 of the reflector element 21 and the concave section 43 of the cavity section 23 are mutually fitted together.

At the height of this fitting-together section, bolt holes are formed from the side face of the portion of the cavity section 23 provided with the concave section 43 towards the center, passing through as far as part of the convex section 42 of the reflector element 21, so that the fitting-together is secured by the bolts 44.

The top of the cavity section 23 is directly connected with the suspension disc 41.

With this construction of the present invention, the cavity section 23 is reliably fixed to the reflector element 21, so there is no possibility of minute displacements of the cavity section 23 being caused by for example mechanical vibration or fluid oscillation etc., and precise control can thus be achieved.

Also, since the suspension disc 41, cavity section 23 and reflector element 21 are reliably coupled, there is no need for connecting rods 25, so the radius of the cavity section 23 can be increased, further simplifying the construction and reducing causes of failure. Increasing the radius of the cavity section 23 increases the neutron leakage rate.

Reflection of neutrons from portions outside the range in which the reactivity is controlled by the reflectors reduces the efficiency of reactivity control by the reflectors, so increasing the volume of the cavity section 23 can improve the effectiveness of control of the reactor rate. Also, in cases where the reactivity must be reduced, a large volume of the cavity section 23 increases the neutron leakage effect, so the lowering of the reactivity can be made more positive, improving stability.

With the construction of the present embodiment as described above, even in cases where the power plant life is further moved, replacement of the core barrel caused by high irradiation levels can be made unnecessary and even more effective reflector control with excellent precision can be achieved by a simplified construction.

### Fourth Embodiment

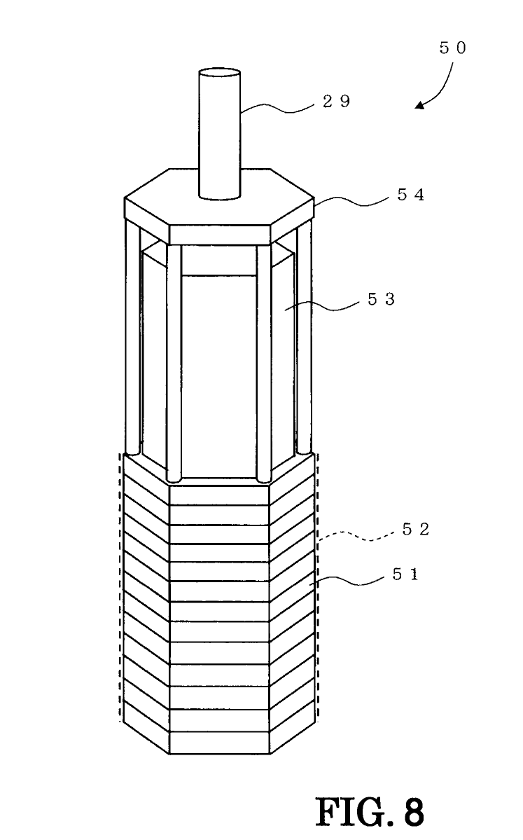

FIG. 8 is a bird's eye view showing the elements in a guide tube of a reflector assembly constituting a fourth embodiment of a fast reactor according to the present invention. In the Figure, the guide tube 26 is not shown, only the elements within the tube being shown.

The present embodiment is a modification of the first embodiment. Whereas, in the case of the first embodiment, the cross-sectional shape of the reflector element 21 and the cavity section 23 is circular, in contrast, a hexagonal reflector assembly 50 according to this embodiment is provided with a hexagonal reflector element 51 whose horizontal cross-section is of regular hexagonal shape, a hexagonal cavity section 53 whose horizontal cross-section is of regular hexagonal shape, and a hexagonal suspension plate 54 within a guide tube 26, which is of regular hexagonal shape, just as in the first embodiment. The circumference of the hexagonal reflector element 51 is covered by a hexagonal cover member 52.

In this way, by combining a guide tube 26 whose external shape is a regular hexagon in horizontal cross-section with a structure whose external shape is a regular hexagon disposed in the interior thereof, the gap between the guide tube 26 and the reflector element 21 can be minimized. Consequently, in conditions in which reflective function by the reflector elements 21 is required, the ratio of leakage of neutrons from the gap between the reflector element 21 and the guide tube 26 to outside the core can be minimized and the effectiveness of control of reactivity in the reactor assemblies 20 can thus be raised.

Also, by making the external shape of the reflector elements 21 a regular hexagonal shape, the reflector elements 21 can be made large compared with when a cylindrical shape is employed, improving the neutron reflection performance.

With the construction of the present embodiment as described above, even in cases where the power plant life is further moved, replacement of the core barrel caused by high irradiation levels can be made unnecessary and even more effective reflector control can be achieved.

### Other Embodiments

While various embodiments of the present invention have been described above, these embodiments are presented merely by way of example and are not intended to restrict the scope of the invention.

Also, the characteristic features of various embodiments may be combined. For example, an embodiment could be adopted that is provided with a guide tube 31 furnished with apertures as in the second embodiment and also provided with linkage between the reflector element 21 and the cavity section 23 as in the third embodiment. Also, a hexagonal reflector element 51, hexagonal cavity section 53 and hexagonal suspension plate 54 that move through the interior of the guide tube 26 as in the fourth embodiment could be employed in these embodiments.

In addition, these embodiments could be put into practice in various other modified forms and various deletions, substitutions or alterations could be made without departing from the gist of the invention.

Just as these embodiments and modifications thereof are included in the scope and gist of the invention, they are included in the invention as set out in the patent claims, and equivalents thereof.

### EXPLANATION OF THE REFERENCE SYMBOLS

1 . . . reactor vessel

2 . . . guard vessel

10 . . . reactor

11 . . . core fuel assembly

12 . . . neutron absorption assembly

13 . . . core fuel region

14 . . . gas plenum region

15 . . . neutron shield

15a . . . inner neutron shield

15b . . . outer neutron shield

16 . . . core barrel

17 . . . shroud

20 . . . reflector assembly

21 . . . reflector element

23 . . . cavity section

24 . . . spring

25 . . . connecting rod

26 . . . guide tube

27 . . . pad

28 . . . orifice

29 . . . connecting section

31 . . . guide tube furnished with apertures

31a . . . apertures

41 . . . suspension disc

42 . . . convex section

43 . . . concave section

44 . . . bolt

50 . . . hexagonal reflector assembly

51 . . . hexagonal reflector element

52 . . . hexagonal covering member

53 . . . hexagonal cavity section

54 . . . hexagonal suspension plate

60 . . . drive mechanism

100 . . . reflector movement region

110 . . . reflector section

120 . . . cavity section

1. A fast reactor in which reflector control is performed to control a core reactivity, by adjusting neutron leakage from a core by moving in a vertical direction a neutron reflector that is arranged radially outside said core, which is bathed in liquid metal coolant, said fast reactor comprising:
a plurality of core fuel assemblies that move in mutually parallel fashion in a vertical direction;
a neutron absorption assembly that moves in said vertical direction, provided in a middle in a horizontal direction of said plurality of core fuel assemblies;
a plurality of reflector assemblies moving in said vertical direction, arranged in a horizontal peripheral region of said core fuel assemblies;
a plurality of neutron shields arranged in a horizontal peripheral region of said core fuel assemblies;
a cylindrical core barrel provided surrounding an entirety of said plurality of neutron shields in said horizontal direction; and
a drive mechanism for said reflector control,
wherein said reflector assemblies comprise:
a reflector element that reflects neutrons flowing out from said core fuel assembly towards said core;
a hollow cavity section arranged perpendicularly above said reflector element for permitting leakage of neutrons flowing out from said core fuel assembly towards outside said core;
a linkage mechanism that links said reflector elements and said cavity sections;
a guide tube defining a space for insertion/removal of said reflector element, said cavity section and said linkage mechanism; and
a connecting section that connects said drive mechanism and said cavity section,
wherein said reflector element and said cavity section are moved vertically through an interior of said guide tube by said drive mechanism.

2. The fast reactor according to claim 1,
wherein said guide tube is equipped with an aperture that permits passage of neutrons in its side face.

3. The fast reactor according to claim 1,
wherein in said linkage mechanism, said reflector element and said cavity section are fitted together and a fitting section of them is secured by means of bolts.

4. The fast reactor according to claim 1,
wherein horizontal cross-sectional external shapes of a plurality of core constituent elements surrounded by said core barrel and comprising said core fuel assembly, said neutron absorption assembly, said reflector assembly and said neutron shield are regular hexagonal shapes of same dimensions, opposite faces of mutually adjacent said constituent elements being parallel, and
wherein a horizontal cross-section of said reflector element and said cavity section accommodated in said space within said guide tube is circular.

5. The fast reactor according to claim 1,
wherein said horizontal cross-sectional external shapes of a plurality of core constituent elements surrounded by said core barrel and comprising said core fuel assembly, said neutron absorption assembly, said reflector assembly and said neutron shield are regular hexagonal shapes of same dimensions, opposite faces of mutually adjacent said constituent elements being parallel, and
wherein said horizontal cross-section of said reflector element and said cavity section accommodated in said space within said guide tube is regular hexagonal.

6. The fast reactor according to claim 1,
wherein said connecting section has a suspension plate and said horizontal cross-section of said reflector element, and said cavity section and said suspension plate accommodated in said space within said guide tube are of regular hexagonal shape.

7. The fast reactor according to claim 1,
wherein a material of said guide tube includes at least one of stainless steel, aluminum, or zirconium.

8. The fast reactor according to claim 1,
wherein said connecting section is provided with a suspension plate and said reflector element is directly coupled with said suspension plate.

9. The fast reactor according to claim 1,
wherein said reflector element is provided with a flow path aperture passing therethrough in said perpendicular direction.

10. A reflector-controlled type fast reactor reflector assembly, in which a core reactivity is controlled by adjusting neutron leakage from a core by moving in a vertical direction a neutron reflector that is arranged radially outside said core, which is bathed in liquid metal coolant, said reflector assembly comprising:
a reflector element that reflects neutrons flowing out from said core fuel assembly towards said core;
a hollow cavity section arranged perpendicularly above said reflector element for permitting leakage of neutrons flowing out from said core fuel assembly towards outside said core;
a linkage mechanism that links said reflector element and said cavity section;
a guide tube defining a space for insertion/removal of said reflector element, said cavity section and said linkage mechanism; and
a connecting section that connects said drive mechanism and said cavity sections,
wherein said reflector element and said cavity section are moved vertically through an interior of said guide tube by said drive mechanism.

11. The fast reactor according to claim 2,
wherein in said linkage mechanism, said reflector element and said cavity section are fitted together and a fitting section of them is secured by means of bolts.

12. The fast reactor according to claim 2,
wherein horizontal cross-sectional external shapes of a plurality of core constituent elements surrounded by said core barrel and comprising said core fuel assembly, said neutron absorption assembly, said reflector assembly and said neutron shield are regular hexagonal shapes of same dimensions, opposite faces of mutually adjacent said constituent elements being parallel, and
wherein a horizontal cross-section of said reflector element and said cavity section accommodated in said space within said guide tube is circular.

13. The fast reactor according to claim 2,
wherein said horizontal cross-sectional external shapes of a plurality of core constituent elements surrounded by said core barrel and comprising said core fuel assembly, said neutron absorption assembly, said reflector assembly and said neutron shield are regular hexagonal shapes of same dimensions, opposite faces of mutually adjacent said constituent elements being parallel, and
wherein said horizontal cross-section of said reflector element and said cavity section accommodated in said space within said guide tube is regular hexagonal.

14. The fast reactor according to claim 2,
wherein said connecting section has a suspension plate and said horizontal cross-section of said reflector element, and said cavity section and said suspension plate accommodated in said space within said guide tube are of regular hexagonal shape.

15. The fast reactor according to claim 2,
wherein a material of said guide tube includes at least one of stainless steel, aluminum, or zirconium.

16. The fast reactor according to claim 2,
wherein said connecting section is provided with a suspension plate and said reflector element is directly coupled with said suspension plate.

17. The fast reactor according to claim 2,
wherein said reflector element is provided with a flow path aperture passing therethrough in said perpendicular direction.
